(19) United States
(12) Patent Application Publication
(10) Pub. No.: US 2022/0118410 A1
(43) Pub. Date: Apr. 21, 2022

(54) SUPER-HYDROPHILIC, SUPER-OLEOPHOBIC MEMBRANES COMPRISING CARBOHYDRATE DERIVATIVES

(71) Applicants: CONSEJO NACIONAL DE INVESTIGACIONES CIENTÍFICAS Y TÉCNICAS (CONICET), Ciudad Autonoma de Buenos Aires (AR); YPF TECNOLOGÍA S.A., Ciudad Autonoma de Buenos Aires (AR); UNIVERSIDAD DE BUENOS AIRES, Ciudad Autonoma de Buenos Aires (AR)

(72) Inventors: Norma Beatriz D'ACCORSO, Buenos Aires (AR); Ricardo Martín NEGRI, Ciudad Autónoma de Buenos Aires (AR); Graciela ROJAS, Avellaneda Prov. de Buenos Aires (AR); Nicolás Alberto GARCÍA SAGGION, Ciudad Autónoma de Buenos Aires (AR); Mariana Daniela SOSA, Ciudad Autónoma de Buenos Aires (AR)

(21) Appl. No.: 17/507,278

(22) Filed: Oct. 21, 2021

Related U.S. Application Data
(60) Provisional application No. 63/094,583, filed on Oct. 21, 2020.

(51) Int. Cl. B01D 67/00; B01D 71/02; B01D 69/02; B01D 71/74; C02F 1/44

(52) U.S. Cl. CPC B01D 67/0079; B01D 71/022; B01D 69/02; B01D 71/74; C02F 1/44; C02F 2103/365; B01D 2323/36; B01D 2323/02; B01D 2323/08; B01D 2323/35; B01D 2325/36

(57) ABSTRACT

Disclosed are super-hydrophobic, super oleophilic membranes comprising a metal mesh comprising copper, a coating comprising a carbohydrate derivative, wherein the carbohydrate derivative is covalently or ionically bonded to a metal mesh surface and methods of preparation thereof. The disclosed membranes are useful for wastewater treatment in the oil industry, in particular for oil/water separation processes.

### FIELD OF THE INVENTION

The present invention refers to membranes for oil/water separation. Specifically, the present invention relates to super-hydrophilic, super-oleophobic membranes comprising carbohydrate derivatives, such as sugar acids and acetals, and to methods of preparation thereof.

### BACKGROUND OF THE INVENTION

The oil industry typically requires large volumes of water to extract oil, both in conventional and non-conventional processes, resulting in large volumes of mixtures of oil and water, which must be separated to recover crude oil. Membrane separation processes are widely used in the treatment of oily wastewater, due to the high separation efficiency and their relatively easy operation and control.

Super-hydrophilic, i.e. highly hydrophilic, membranes, such as coated metal meshed described in U.S. Patent Application No. 62/929,454, have an increased affinity towards water and repel organic substances, which allows reducing treatment times of oil and water separation processes.

Super-oleophobicity, i.e. an increased level of oleophobicity, of a surface is observed when contact angles between a surface and a drop of oil reaches a value greater than 150°. Super-oleophobic surfaces repel substances such as oil and petroleum, making them adapted for oil/water separation, and oil capture process, as well as for oil-repellent or self-cleaning coatings.

Since the properties relating to wettability of a substrate surface partially depend on its chemical composition, the wettability of a surface may be altered by modifying the chemical structure of the substrate. When a super-oleophobic surface is meant to operate underwater, a material comprising a chemical super-hydrophilic coating for atmospheric conditions may be prepared, from which the desired underwater super-oleophobic properties can be obtained. (see, e.g., Yong, J.; Chen, F.; Yang, Q.; Huo, J.; Hou, X. Super-oleophobic Surfaces. Chemical Society Reviews 2017, 46 (14), 4168-4217. https://doi.org/10.1039/C6CS00751A).

Several methods have been described to prepare underwater super-oleophobic surfaces, such as electrochemical deposition, self-assembly, dip coating, chemical etching, moulding, or anodizing. Electrochemical techniques are usually employed to modify substrates by deposition of inorganic oxides.

The super-oleophilic surfaces obtained from organic materials generally consist of polymers, some of which may be harmful to the environment. In addition, syntheses of these polymers can often be complex and costly.

There is therefore a need to provide super-hydrophilic membranes having improved underwater super-oleophobicity properties, obtained from low cost and renewable materials, and that result in more efficient oil/water separation processes.

### BRIEF DESCRIPTION OF THE INVENTION

The present invention is based on the unexpected super-hydrophilicity at atmospheric pressure and underwater super-oleophobicity obtained by treating a porous substrate, such as a porous metal mesh, with simple carbohydrate molecules obtained from renewable biomass.

It is therefore an object of the present invention a membrane with the features set forth in claim 1, i.e. a super-hydrophilic and underwater super-oleophobic membrane. Other features of the membrane provided by the invention are set forth in claims 2 to 4.

It is another object of the present invention a method to prepare a super-hydrophilic and underwater super-oleophobic membrane, with the features as set forth in claim 5. Other features of the method provided by the invention are set forth in claims 6 to 11.

The membranes disclosed herein can be used in the treatment of production water, co-production water and flowback water from the oil production industry, as well as residual water from the petroleum refining industry.

Recovery of purified water after a separation process using the membranes provided by the invention allows recycling and reusing water, which is desirable from both environmental and economical standpoints.

### BRIEF DESCRIPTION OF THE FIGURES

FIG. 1 is a schematic representation of the pyrolysis reaction forming a calcinated metal as a first modification step to obtain a membrane according to the invention.

FIG. 2 is a schematic representation of the chemical reaction forming acetals from a carbohydrate on the surface of a metal mesh to obtain a membrane according to the invention.

FIG. 3 shows a photograph of a drop of dichloromethane on the surface of a type A membrane of the invention according to an exemplary embodiment.

FIG. 4 shows a photograph of an experimental setup for an oil/water separation process using a type A membrane of the invention according to an exemplary embodiment.

FIG. 5 is a schematic representation of the interaction between aldaric acids and a brass mesh surface in the membrane of the invention according to an exemplary embodiment.

FIG. 6 shows SEM images of the starting materials and membranes according to the invention.

FIG. 7 shows a photograph of an experimental setup for an oil/water separation process using a type M membrane of the invention according to an exemplary embodiment.

### DETAILED DESCRIPTION

The invention will be described in further detail with reference to the accompanying figures below.

As used herein, the term “membrane” refers to a product or device acting as a selective barrier and useful in separation processes, such as an oil/water separation process. The term includes products obtained by coating and modifying a substrate or support, such as a metal mesh, as will be described in further detail below.

The term “carbohydrate” as used herein related to biomolecules consisting essentially of carbon, hydrogen and oxygen and comprising compounds commonly referred to as “sugars”. A “carbohydrate derivative” as used herein is a molecule derived from a carbohydrate by means of a chemical reaction. Examples include sugar acids, such as aldonic acids, having a general formula HOOC—(CHOH)ₙ—CH₂OH, and salts thereof; aldaric acids having the general formula HOOC—(CHOH)ₙ—COOH, and salts thereof, i.e. having the general formula ⁻OOC—(CHOH)ₙ—CH₂OH or ⁻OOC—(CHOH)ₙ—COO⁻, as well as acetals, i.e. compounds comprising functional groups comprising a R₂C(OR′)₂ moiety, where R represents an organic moiety or hydrogen and R′ represents organic moieties and not hydrogen.

As used herein, the given numerical ranges of variables or physical quantities are intended to comprise the end values of the range as well as any intermediate values. The terms “approximately” or “about” indicate that a given variable or physical quantity may be within a range of +/−10% of the given numerical value. The terms “oil”, “oil phase”, “organic phase” and equivalents are used in the present application indistinctly in order to indicate any hydrocarbon phase to be separated from a mixture with an aqueous phase. The acronyms SEM refers to “scanning electron microscopy”.

The present invention provides super-hydrophilic membranes obtained by modification of a porous metal mesh, using pyrolytic as well as electrolytic methods by which a mesh surface is modified to comprise carbohydrate derivatives, such as sugar acids, i.e. aldonic or aldaric acids, or acetals, which are chemically bonded, either by means or covalent or ionic bonds, to the metal mesh surface. By using the methods disclosed herein, the super-hydrophilic membranes provided by the invention show underwater super-oleophobicity properties.

The membrane provided by the present invention comprises a support or substrate, i.e. a metal mesh. The support preferably comprises copper, or a copper alloy, such as brass, i.e. an alloy of copper and zinc, or bronze. The support does not provide significant oil/water separation efficiency per se, except for a physical separation related to mesh or pore size. In the context of the invention, metal meshes have a pore size of about 70 to 100 μm, preferably 77 μm.

The metal mesh may be cleaned in an organic solvent, e.g. acetone, and dried at a temperature of about 30° C., before being subjected to a modification treatment. The metal mesh is then subjected to a modification treatment, by which a super-hydrophilic coating displaying underwater super-oleophobicity properties can be obtained.

The treatment includes the use of simple carbohydrates, such as sugars and particularly monosaccharides. These compounds may be advantageously obtained from renewable biomass. Examples of the carbohydrates that may be used to prepare the membranes provided by the invention includes sugars such as glucose, mannose, lactose cellobiose, maltose, other low-cost reducing monosaccharides or disaccharides and mixtures thereof, as well as sugar acids such as aldaric acids and aldonic acids and mixtures or salts thereof, such as mucic acid and calcium gluconate. It is important to remark that, advantageously, the chemical nature of the carbohydrates tested to prepare the membranes does not significantly affect the advantageous aspects of the invention.

The membranes provided by the invention may be obtained in a two-step modification process, by subjecting the metal mesh to a pyrolytic treatment as a first step, by which nanostructured oxides, i.e. copper oxides and/or the corresponding oxides according to metals present in the mesh.

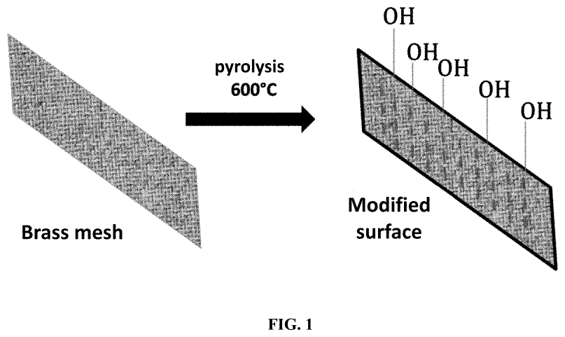

The pyrolytic treatment is carried out at a temperature of about 400 to 800° C., preferably about 550° C. to 650° C., for 0.5 to 2 h, preferably about 1 h, using conventional equipment such as a stove or a furnace. FIG. 1 illustrates the pyrolytic treatment used for the first modification step, in which the generation of nanostructured oxides is represented by hydroxyl groups at the surface of the pyrolyzed metal mesh.

The metal meshes subjected to this pyrolytic treatment were found to have underwater contact angles for dichloromethane of about 150°.

As a second step, the pyrolyzed membranes are contacted with a solution comprising a reducing carbohydrate, such as glucose, mannose, lactose, and the like in an acid medium, e.g. using sulphuric acid, and an inert solvent, such as dimethylformamide. The reaction is left to proceed of about 25° C. to 35° C., preferably about 30° C., under permanent stirring. This step may be carried out in an appropriate vessel, such as a round-bottom flask, which may be blanketed using an inert gas during a first reaction time, such as during the first hour, in order to displace air from the reaction system. The reaction system may be further sealed or closed to avoid the entry of air.

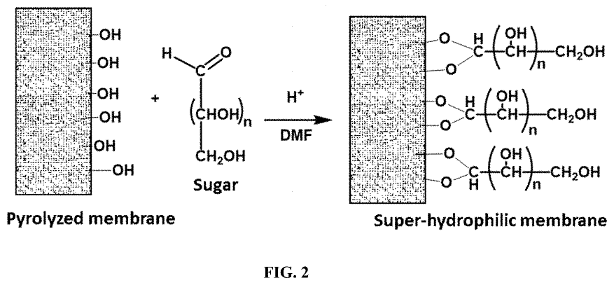

In the reaction between the sugar and the hydroxyl groups of the pyrolyzed membrane, an acetal is formed, as illustrated in FIG. 2, which is covalently bonded to the metal mesh surface, thereby forming a coating on the metal mesh surface. In this manner, a membrane with super-hydrophilic properties is obtained, also displaying super-oleophobic properties, as shown by an underwater contact angles for dichloromethane of about 165°.

The membranes of the invention may also be prepared in a single modification step, comprising an electrolysis process carried out in an aqueous solution comprising carbohydrates.

To this end, an electrolytic cell can be manufactured using the metal mesh as a working electrode and a copper electrode as a counter electrode and reference electrode. The electrodes are submerged in a basic aqueous medium, e.g. comprising an alkaline compound such as sodium hydroxide, further comprising carbohydrates. Carbohydrates in the basic medium are in the form of aldaric acid or aldonic acid salts.

A constant voltage is subsequently applied between both electrodes for a predetermined period of time. This process may be repeated several times.

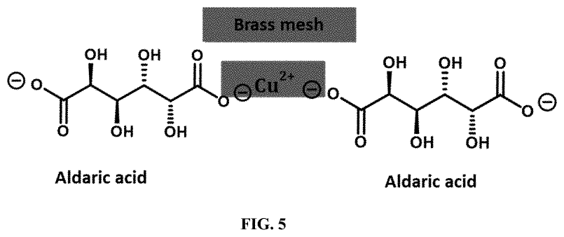

During the electrolysis, a coating is generated in the metal mesh surface, as illustrated in FIG. 5, through an ionic interaction between Cu²⁺ cations in the metal mesh surface and anionic COO⁻ groups of sugar acids.

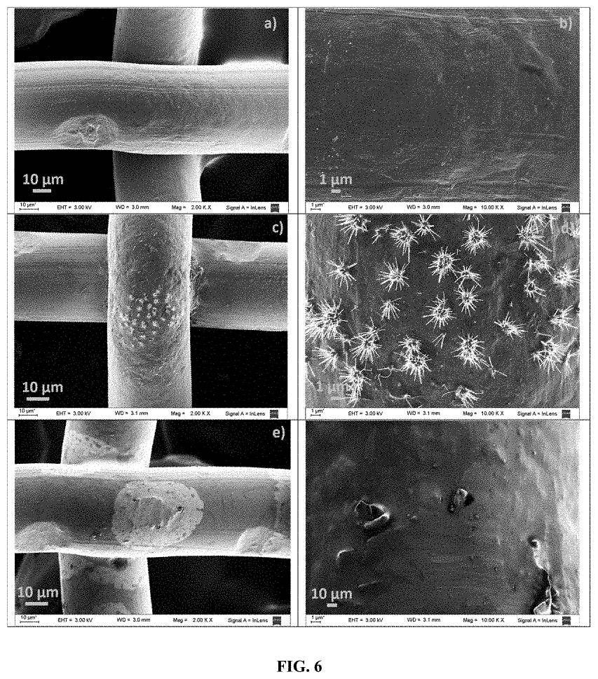

FIG. 6 shows SEM micrographs of the mesh surface before and after the treatment, confirming the deposition of material forming the coating of the metal mesh during the electrolysis process.

The membranes obtained using this modification process also display underwater super-oleophobicity, as shown by underwater contact angles for dichloromethane of about 163°.

Therefore, the membranes provided by the invention obtained in the above modification processes are advantageously adapted for oil/water separation, and for general separation processes relating to an organic phase and an aqueous phase.

Further, it was found that by varying the carbohydrate solution concentration as well as conditions such as the electrolysis parameters, i.e. applied voltage, time, number of repetitions, a more stable and reusable membrane may be obtained. Using a 1% w/w carbohydrate solution, with a voltage of 1000 mV applied during 20 minutes and a number of repeats between 1 and 3, the obtained membranes may be reused up to five times.

The super-hydrophilic, super-oleophobic membranes and their methods of preparation and use will be illustrated below by means of non-limiting examples.

### EXAMPLES

### Example 1: Membranes Obtained with Two Modification Steps

### Membrane Synthesis

Brass meshes, i.e. comprising a copper-zinc allow having an atomic Cu:Zn ratio of about 4:1, were modified using a method comprising two modification steps.

As pre-treatment, the brass meshes were immersed in acetone and subsequently dried in a stove at 30° C.

As a first modification step, the meshes were placed inside a stove set at 600° C. for 1 hour, in order for nanostructured oxides to be generated. FIG. 1 shows the pyrolytic treatment used for the first modification step.

For the second modification step, acetals where formed in the surface of the meshes. To this end, a chemical reaction with D-glucose in dimethylformamide (DMF) was carried out in a round-bottom flask. The mixture was left to react in the flask during 12 h at 30° C. under constant stirring. During the first hour, the reaction medium was injected with gaseous argon to displace the air contained within the flask. The flask was subsequently closed and sealed to prevent the entry of air.

Finally, the obtained membrane was washed using distilled water until neutrality of the washing water, and then left in a stove to dry at 30° C.

### Contact Angle

The contact angle of the prepared membranes was measured using the “under water” methodology. Drops of dichloromethane (CH₂Cl₂) were deposited on the membrane surfaces while immersed in distilled water.

The aim of this experiment is to study the interactions between an organic phase and the deposit on the modified brass mesh.

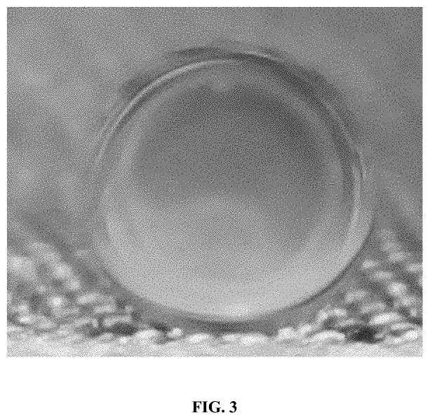

For the measurement, the membrane was placed in a small Petri dish with distilled water. Subsequently, a drop of dichloromethane of approximately 1 μL was added using a Hamilton syringe. Using a microscope (×1000) connected to a computer, images of the dichloromethane-membrane interphase were acquired, as seen in FIG. 3.

The contact angles between the membrane and the drops was determined using the software ImageJ.

Table 1 below summarizes the “under water” contact angles obtained for dichloromethane in contact with calcinated brass meshes and for a “Type A” membrane, or “membrane A”, i.e. the membrane as obtained in the synthesis of Example 1.

TABLE 1
Measured contact angles for calcinated
brass meses and type A membrane

| Sample | Calcinated mesh | Membrane A |
|---|---|---|
| Contact angle | 150 ± 6 | 165 ± 2 |
| (degrees) | | |

Experimental results show that the pyrolytic treatment, i.e. the first modification step, produces a membrane having super-hydrophilicity properties, while the subsequent treatment, i.e. the second modification step generates a super-hydrophilic and super-oleophobic membrane.

### Oil-Water Separation

An oil/water mixture separation process was carried out using membrane A.

A horizontal glass tube was provided with a membrane on its middle section. The membrane is placed in a Teflon disk inserted between the two halves of the glass tube. In this manner, the liquids in the mixture can flow from one half of the tube to the other through the membrane.

The experiment consisted in placing 10 mL of distilled water in one half of the tube and then adding 0.5 mL of oil in the same half. The mixture volume was forced to flow to the opposite side of the tube, i.e. the other half, using a pressure differential between both sections that can be obtained by a difference in height, i.e. by placing one end of the tube at a greater height than the opposite end by means of a manual movement. In this manner, the mixture must flow through the membrane to reach the opposite side of the system. The movement was repeated ten times, registering which sample successfully flowed through the membrane. The membrane was then washed with distilled water and dried at atmospheric conditions.

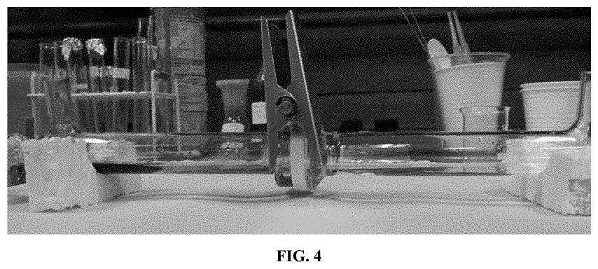

As a result of this experiments, type A membranes were observed to differentially allow the passage of water, while blocking the passage of oil, as can be seen in FIG. 4.

### Example 2: Membranes Obtained with One Modification Step

### Membrane Synthesis

Brass meshes, i.e. comprising a copper-zinc allow having an atomic Cu:Zn ratio of about 4:1, were modified using a method comprising one modification step.

As pre-treatment, the brass meshes were immersed in acetone and subsequently dried in a stove at 30° C.

For the modification step of the metal meshes, an electrolysis was carried out in a solution comprising mucic acid, employing a mesh sample as working electrode, connecting a copper plate as a counter-electrode and reference electrode. Both electrodes were immersed into a solution comprising carbohydrates, the pH of which was adjusted to 12 by addition of solid NaOH. Once the experimental setup was prepared, a constant voltage was applied between the two electrodes during a predetermined period of time. In this manner, several membranes were obtained by modifying parameters such as the nature of the carbohydrate, carbohydrate concentration [HdC], fixed electric potential or voltage (V), time (Δt) and number of repeats (n). FIG. 5 shows the interaction of the carbohydrate with the surface of the brass mesh for an aldaric acid.

Table 2 below summarizes the parameters used in the preparation of different separation membranes.

TABLE 2
Varied parameters for membrane preparation

| | |
|---|---|
| Carbohydrate concentration [HdC] (% w/w) | 0.1; 1.0; 5.0 |
| Electric potential V (mV) | 500; 1000 and 2000 |
| Amperometry time Δt (minutes) | 0, 5, 20 |
| Number of repetitions n | 1, 3 and 5 |

From the different separation membranes which were synthesized as detailed above, the following membranes were selected, corresponding to the parameters in Table 3 below.

TABLE 3
Parameters for selected membrane types

| Membrane type | [HdC] (% w/w) | V (mV) | Δt (min) | n |
|---|---|---|---|---|
| G | 1.0 | 1000 | 20 | 1 |
| M | 1.0 | 1000 | 20 | 3 |

The starting materials, i.e. brass meshes, the prepared membranes and the membranes after being used in the separation of oil/water mixtures were observed through SEM, as shown in FIG. 6.

FIG. 6 a) and b) show SEM micrographs for the starting materials, i.e. brass meshes without any modification treatment. It can be seen that metallic strands have a rough surface. FIG. 6 c) and d) show images under two different magnifications for a type M membrane. This membrane was found to comprise on its surface spherical-shaped particles, from which strands of material extend. Further, FIG. 6 e) and f) show a type M membrane after being used in an oil/water separation process. After this process, the membrane showed markings on its surface. SEM imaging also confirmed the deposition of material over the surface of the brass meshes.

### Contact Angle

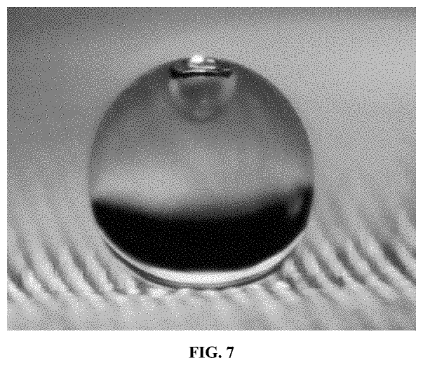

Contact angles were measured, using the “under water” methodology as described above for Example 1, for both G and M type membranes. Results are summarized in Table 4 below, while FIG. 7 shows an image taken during measurements.

TABLE 4
Measured contact angles for untreated brass
meses and type G and type M membranes

| Sample | Brass mesh | Membrane G | Membrane M |
|---|---|---|---|
| Contact angle | 133 ± 4 | 163 ± 1 | 163 ± 2 |
| (degrees) | | | |

“Under water” contact angles for meshes obtained using the electrochemical method as described above in the presence of carbohydrates were greater than 152°, i.e. at least 14% higher than that of untreated brass meshes. The obtained membranes may thus be considered super-oleophobic.

### Oil-Water Separation

An oil/water mixture separation process was carried out using membranes G and M, as well as untreated brass meshes.

The experimental device and methodology were equivalent to those used in Example 1.

For this experiment, each of the membranes was reused five times to assess membrane performance and reusability for oil and water separation processes.

It was found that the untreated brass mesh does not present selectivity towards any of the components of the oil/water mixtures, since both oil and water managed to flow through the metal mesh.

For membranes prepared with carbohydrates, it was verified that, during their first used, a differential selectivity towards the flow of water, while repelling the flow of oil, was observed. Nonetheless, in several cases, this differential behaviour was lost after successive reusing of the membranes.

Membranes obtained with the parameters of Table 3, i.e. G and M membranes, were found to achieve a superior performance compared to other membranes synthesized with different values for the parameters, since they repelled the flow of oil during the five reuses.

### Water Volumetric Flow Rate

The volume of water capable of flowing through the membranes during a given time was determined. To this end, a vertical tube was set up vertically, comprising the synthesized membranes at its base. The tube was fed using a hose connected to a water tap. The tap was opened until a water column of 3 cm in height was obtained.

For each sample, the passage of tap water through the membranes was determined and the volume was measured along with the time required to flow through the membrane. The average measured volumetric flows are shown in Table 5.

TABLE 4
Measured average volumetric water flow rate for untreated
brass meses and type G and type M membranes

| Sample | Brass mesh | Membrane G | Membrane M |
|---|---|---|---|
| Volumetric water flow rate | 113 ± 6 | 100 ± 6 | 97 ± 6 |
| (cm³/s) | | | |

The obtained results indicate that functionalized or modified membranes reached a volumetric flow somewhat lower than untreated brass meshes, by about 13-14%. In addition, the nature of the deposited carbohydrate was found to have little effect on the flow through the membranes.

The water flow rate was also measured when no membrane or mesh is used, yielding an average value of about 115 cm³/s, indicating that the presence of the brass meshes had little impact on the reference value.

Similarly, the use of membranes treated with carbohydrates resulted in a water flow rate about 15% lower of the reference value.

1. A membrane comprising:
a metal mesh comprising copper,
a coating comprising a carbohydrate derivative,
wherein the carbohydrate derivative is covalently or ionically bonded to a metal mesh surface.

2. The membrane according to claim 1, wherein the carbohydrate derivative is selected from an aldaric acid, an aldonic acid and an acetal.

3. The membrane according to claim 2, wherein the carbohydrate derivative is selected from mucic acid and calcium gluconate and ionically bonded to a mesh surface.

4. The membrane according to claim 2, wherein the carbohydrate derivative is an acetal and covalently bonded to a mesh surface.

5. A method to prepare the membrane according to claim 1, wherein the method comprises the steps of:
providing a metal mesh comprising copper,
cleaning the metal mesh with an organic solvent; and
modifying a metal mesh surface with a carbohydrate derivative.

6. The method according to claim 5, wherein the step of modifying a metal mesh surface comprises the steps of:
subjecting the metal mesh to a pyrolytic treatment, thereby obtaining a pyrolyzed metal mesh; and reacting a pyrolyzed metal mesh surface with a solution comprising a carbohydrate selected from glucose, lactose and mannose in an acidic medium, thereby forming an acetal covalently bonded to a pyrolyzed mesh surface.

7. The method according to claim 6, wherein the pyrolytic treatment is carried out at 600° C. for 1 hour.

8. The method according to claim 7, wherein the step of reacting the metal mesh surface is carried out at 30° C. for 12 h under constant stirring.

9. The method according to claim 5, wherein the step of modifying a metal mesh surface comprises subjecting the metal mesh surface to an electrolysis in a solution comprising a carbohydrate derivative.

10. The method according to claim 9, wherein the carbohydrate derivative is selected from an aldaric acid and an aldonic acid.

11. The method according to claim 10, wherein the aldaric acid is mucic acid.
